(19) United States
(12) Patent Application Publication
(10) Pub. No.: US 2003/0061384 A1
(43) Pub. Date: Mar. 27, 2003

(54) System and method of addressing and configuring a remote device

(76) Inventor: Bryce Nakatani, Fallbrook, CA (US)

Correspondence Address: Pillsbury Winthrop LLP, Intellectual Property Group, 50 Fremont Street, San Francisco, CA, 94105, US

(21) Appl. No.: 09/965,520

(22) Filed: Sep. 25, 2001

(51) Int. Cl. G06F 15/16; G06F 15/177

(52) U.S. Cl. 709/245; 709/220

(57) ABSTRACT

A system and method of addressing and configuring a remote device implement a dynamic device addressing and configuration protocol. Equipment such as industrial automation devices may be dynamically coupled to a communications network, providing flexibility and redundancy in network device configuration. Industrial automation devices may be assigned both network address information as well as operational parameters according to a dynamic protocol.

### FIELD OF THE INVENTION

Aspects of the present invention relate generally to monitor and control systems, and more particularly to a system and method of utilizing a network protocol dynamically to address and to configure a remote device implemented in a monitor and control system.

### BRIEF DESCRIPTION OF THE DRAWINGS

FIG. 1 is a simplified block diagram illustrating one embodiment of a system which may dynamically address and configure a remote device.

FIG. 2 is a simplified block diagram illustrating one embodiment of an industrial automation device.

FIG. 3 is a simplified block diagram illustrating another embodiment of an industrial automation device.

FIG. 4 is a simplified block diagram illustrating one embodiment of an address management server.

FIG. 5 is a simplified block diagram illustrating one embodiment of an apparatus facilitating dynamic addressing and configuration of a remote device.

FIG. 6 is a simplified flow diagram illustrating the general operational flow of one embodiment of a method of dynamically addressing and configuring a remote device.

FIGS. 7A-B are simplified flow diagrams illustrating the general operational flow of another embodiment of a method of dynamically addressing and configuring a remote device.

### DETAILED DESCRIPTION

Embodiments of the present invention overcome various shortcomings of conventional technology, providing dynamic device addressing and configuration in an industrial monitoring system.

In accordance with one aspect of the present invention, a system and method of dynamically addressing a remote device address, initialize, and communicate with industrial automation devices (IADs) according to a dynamic network addressing protocol. Dynamic protocols may be implemented such that configuration information may also be transmitted from a network device, such as an address management server (AMS), to an IAD.

The foregoing and other aspects of various embodiments of the present invention will be apparent through examination of the following detailed description thereof in conjunction with the accompanying drawings.

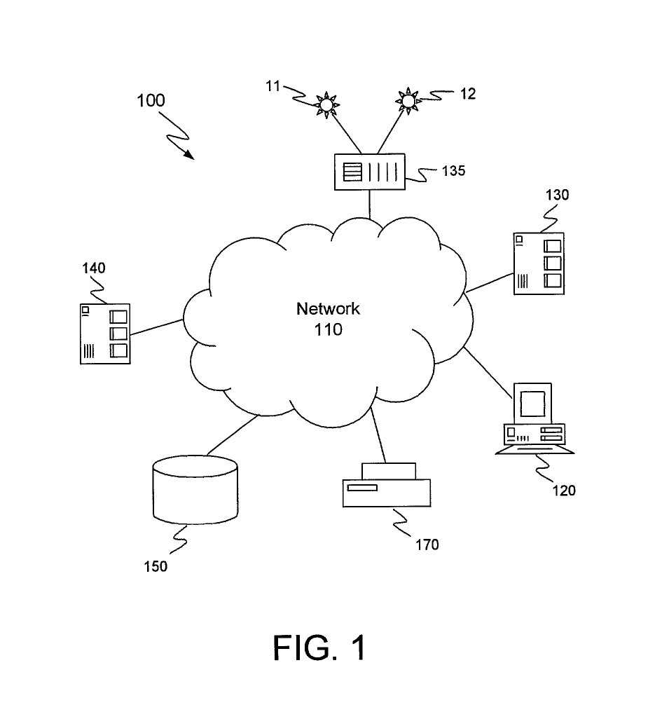

Turning now to the drawings, FIG. 1 is a simplified block diagram illustrating one embodiment of a system which may dynamically address and configure a remote device. In the exemplary embodiment, system 100 generally comprises one or more industrial automation devices, such as IAD 135, coupled to one or more address management servers, such as AMS 130, via a communications network 110. System 100 may also comprise one or more network clients, such as host 120, and domain name servers, such as DNS 140, as well as storage media and peripheral devices, represented by reference numerals 150 and 170, respectively.

For clarity, only a single IAD 135, AMS 130, host 120, and DNS 140, have been depicted in FIG. 1. Those of skill in the art will appreciate that the FIG. 1 embodiment is presented for illustrative purposes only, and that system 100 may be implemented with any number of additional IADs, AMSs, hosts, and DNSs; the number and variety of each device coupled to network 110 may vary in accordance with system requirements. In some embodiments, the functionality of one device, such as DNS 140, for example, may reside on another device, such as AMS 130.

Remote host 120 may be capable of two-way communication via communications network 110. In that regard, host 120 may communicate with IAD 135, AMS 130, and DNS 140 via network 110 or via one or more additional networks (not shown) which may be coupled to network 110. It will be appreciated by those of skill in the art that host 120, IAD 135, AMS 130, and DNS 140 may be coupled via any number of additional networks without inventive faculty.

In some embodiments, host 120 may be a personal computer, personal digital assistant (PDA), wireless telephone, or other network-enabled computing device. In operation, host 120 may execute software or other programming instructions encoded on a computer-readable storage medium, and additionally may communicate with IAD 135 for monitor and control purposes. For example, host 120 may query IAD 135 for data transmitted from one or more meters or monitor devices, such as a sensor 11, connected to IAD 135. Additionally or alternatively, host 120 may transmit control signals to IAD 135 which may direct IAD 135 to take some action with respect to an actuator 12 or other remote device; for example, signals transmitted from IAD 135 may affect the function of actuator 12, turn on a motor, activate a solenoid, illuminate a warning light, issue an alarm, or the like, depending upon the configuration and functionality of actuator 12 or other remote devices to be controlled by IAD 135.

It is well understood in the art that any number or variety of peripheral equipment, such as device 170, may additionally be coupled to network 110 without inventive faculty. Examples of such peripheral devices include, but are not limited to: servers; computers; workstations; terminals; input devices; output devices; printers; plotters; routers; bridges; cameras or video monitors; sensors; actuators; or any other network-enabled device known in the art. Peripheral device 170 may be coupled to network 110 directly, as illustrated in FIG. 1, or indirectly, for example, through IAD 135, such that the functionality or operation of device 170 may be monitored or controlled by sensors or actuators as generally described above.

AMS 130 may identify a device such as, for example, IAD 135, when IAD 135 is initially connected to network 110. AMS 130 may additionally assign a unique network address to each networked IAD 135; accordingly, other devices coupled to network 110, such as host 120 and DNS 140, for example, may communicate with IAD 135. With respect to identification of newly connected devices on network 110, AMS 130 may identify such a device by continuously monitoring, querying, or “pinging,” network 110 for unknown or newly connected devices such as IAD 135. In some embodiments, AMS 130 may identify a device after receiving an identification request transmitted directly from the newly connected device; in accordance with this embodiment, IAD 135 may broadcast a request for assignment of a dynamic network address across network 110. Upon receipt of such a broadcast signal, AMS 130 may identify IAD 135, assign IAD 135 a dynamic network address, and apprise IAD 135 of the assigned address. AMS 130 may additionally apprise host 120 of the network address assigned to a newly identified IAD.

Additionally or alternatively, AMS 130 may identify an unknown device after receiving an instruction to do so, such as from host 120, for example. In accordance with this embodiment, host 120 may transmit signals to AMS 130 apprising AMS 130 that a device, such as IAD 135 (which may be unknown to AMS 130) has recently been connected to network 110. Responsive to such signals, AMS 130 may execute appropriate procedures to identify IAD 135, to assign IAD 135 a dynamic network address, and to apprise IAD 135 of the newly assigned address. As noted above, in some embodiments, AMS 130 may notify host 120 of the network address assigned to the newly identified IAD.

In operation, AMS 130 may assign IAD 135 a unique network address according to a dynamic protocol such as, for example, Dynamic Host Configuration Protocol (DHCP). Implementation of a dynamic protocol may eliminate the requirement that host 120 be re-booted if IAD 135, or any other networked component so addressed, is disconnected from network 110 or otherwise fails. In cases of network or component failure, a dynamic network addressing protocol may enable host 120 to be redirected, through AMS 130, to a replacement or backup IAD 135 without re-booting.

As set forth in greater detail below, a replacement IAD 135 may be connected to network 110 prior to failure of an original IAD 135; those of skill in the art will appreciate that pre-failure installation of a replacement IAD 135 may provide fail-safe component redundancy and network system integrity. Alternatively, a replacement IAD 135 may be connected to network 110 after failure of an original IAD 135; in that regard, implementation of a dynamic network address protocol system may allow host 120 to communicate with a replacement IAD or an additional IAD coupled to network 110 subsequent to the boot process at host 120. Such a network addressing scheme employing dynamic protocols may provide “plug-and-play” versatility, improving network scalability and flexibility. In some embodiments, AMS 130 may be embodied in a computer server, a personal computer, a PDA, a wireless telephone, or other network-enabled electronic or computing device.

As is generally known in the art, DNS 140 may enable one networked device such as host 120, for example, to locate another networked device such as IAD 135, for example, through use of a domain name rather than a numerical network address. In that regard, when host 120 wishes to communicate with IAD 135, DNS 140 may direct data communication from host 120 to IAD 135 without requiring host 120 to provide an exact network address for IAD 135; rather, DNS 140 may maintain a cross-reference table or other data structure in which a domain name or other unique identifier string may be associated with a respective network address. When host 120 provides the domain name of a particular IAD 135, the network address of that particular IAD 135 may be identified by DNS 140. As noted above with reference to AMS 130, embodiments of DNS 140 may be implemented in a computer server, a personal computer, a PDA, a wireless telephone, or similar network-enabled electronic or computing devices.

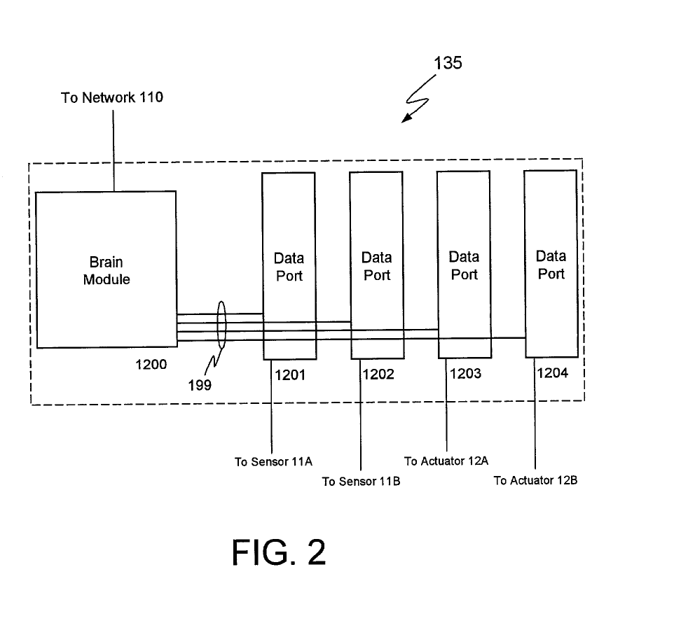

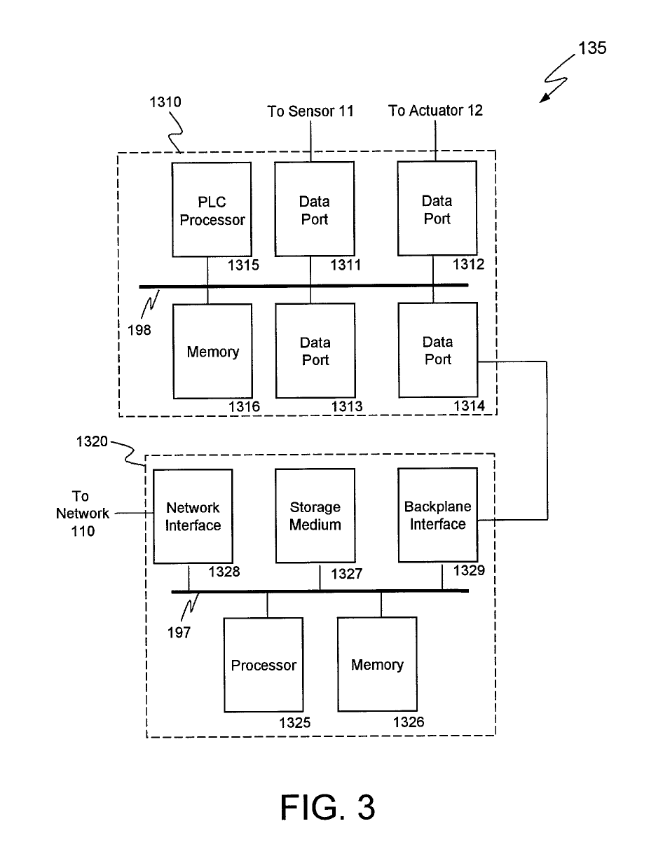

IAD 135 may be any apparatus known in the art capable of monitoring input from sensor 11, sending output or control signals to actuator 12, and communicating with other networked devices, such as host 120, across network 110. Accordingly, IAD 135 may be embodied in a computer server, a personal computer or workstation, a PDA, a wireless telephone, an input/output monitoring device, or other network-enabled electronic or computing equipment. As set forth in detail below with reference to FIGS. 2 and 3, IAD 135 may include suitable hardware, firmware, software, or a combination thereof operative to transmit and to receive data.

Sensor 11 may be any device known in the art for collecting data; similarly, actuator 12 may be a device which is responsive to output signals transmitted from IAD 135. Only one sensor 11 and one actuator 12 are illustrated in FIG. 1 for clarity; it will be appreciated that IAD 135 may be connected to any number of additional sensor or actuator devices.

Sensor 11 may be embodied in any number of monitoring devices such as: thermistors, thermocouples, or other temperature measuring equipment; tachometers; speedometers; pressure gauges; fluid flow meters; gyroscopes; infrared or motion detectors; acoustic or other audio signal sensors; or any other similar meters, gauges, or indicators capable of generating output which may be monitored by IAD 135. Where sensor 11 is configured to provide analog signals, appropriate analog to digital (A/D) converters (not shown) may be implemented.

In the FIG. 1 embodiment, actuator 12 may represent a wide range of equipment and devices such as, for example: control modules implemented in computer hardware or software; computer-based or electronically controlled machinery; servos; hydraulic systems; electronic circuits; peripheral equipment such as device 170; and any other devices to be controlled by IAD 135 or host 120.

Network 110 may be any communications network known in the art, including the Internet, a local area network (LAN), a wide area network (WAN), a Virtual Private Network (VPN), or any system providing communication capability between host 120, AMS 130, IAD 135, and DNS 140. In addition, network 110 may be configured in accordance with any topology known in the art, including star, ring, bus, or any combination thereof.

Storage medium 150 may be a conventional read/write memory such as a magnetic disk drive, a magneto-optical drive, an optical disk drive, a floppy disk drive, a compact-disk read only memory (CD-ROM) drive, a digital versatile disk read only memory (DVD-ROM), a digital versatile disk random access memory (DVD-RAM), transistor-based memory, or other computer-readable memory device for storing and retrieving data. As generally known in the art, various other networked devices depicted in FIG. 1 may communicate with storage medium 150 via network 110.

FIG. 2 is a simplified block diagram illustrating one embodiment of an industrial automation device constructed and operative for use in conjunction with a system for dynamic device addressing and configuration. In this embodiment, IAD 135 may be operative as an input/output monitoring device. IAD 135 generally comprises a brain module 1200 coupled to at least one port, such as data ports 1201-1204. For illustrative purposes only four data ports 1201-1204 are depicted in FIG. 2. It is understood that IAD 135 may be implemented with any desired number of data ports.

Sensors 11A and 11B, actuators 12A and 12B, as well as any other device to be monitored or controlled by IAD 135, may be coupled to one or more of data ports 1201-1204 as illustrated in FIG. 2. Equipment coupled to data ports 1201-1204 may include input/output modules, control modules, and other peripheral devices such as described above with reference to FIG. 1.

Brain module 1200 may be any machine intelligence capable of two-way data communication with data ports 1201-1204 and any peripheral devices, sensors, or actuators coupled thereto. Additionally, brain module 1200 may include an interface (not shown) providing two-way data communication between brain module 1200 and a remote computer, such as host 120, for example, over network 110 (as depicted in FIG. 1). In operation, brain module 1200 may execute program instructions encoded on computer-readable medium, for example, or implemented in firmware or hardware; such software or hardware instructions may affect operation of actuators 12A and 12B, or devices coupled thereto, through data ports 1203 and 1204.

In that regard, brain module 1200 may incorporate a microprocessor or microcontroller based microcomputer (not shown) and include sufficient communications interfaces (logical and physical layers) to enable the data communication illustrated graphically in FIG. 2. One or more communications interfaces may generally be dedicated to communicating with data ports 1201-1204, and one or more communications interfaces may generally be dedicated to communicating to other networked devices, such as equipment connected to a LAN, a WAN, a VPN, and the like.

In one embodiment, the interface between brain module 1200 and data ports 1201-1204 may be integrated, or hard-wired, as represented by a bus 199 in FIG. 2. By way of example, the data connection via bus 199 may be a serial or parallel link. Alternatively, the data connection may be any type generally known in the art for communicating or transmitting data across a computer network; examples of such networking connections and protocols include, but are not limited to, Transmission Control Protocol/Internet Protocol (TCP/IP), Ethernet, Fiber Distributed Data Interface (FDDI), ARCNET, token bus or token ring networks, Universal Serial Bus (USB), and Institute of Electrical and Electronics Engineers (IEEE) Standard 1394 (typically referred to as “FireWire”).

Other types of data network interfaces and protocols are within the scope and contemplation of the present disclosure. In particular, brain module 1200 may be configured to transmit data to, and receive data from, data ports 1201-1204 using wireless data communication techniques, such as infrared (IR) or radio frequency (RF) signals, for example, or other forms of wireless communication. In such a wireless embodiment, brain module 1200 and one or more of data ports 1201-1204 may be capable of communicating via the Bluetooth(™) standard, for example. Those of skill in the art will appreciate that the hardware backplane, or bus 199 (i.e. wire-line data connection), may be supplanted by an RF Personal Area Network (PAN). Similarly, brain module 1200 may be constructed and configured to communicate with the network via wireless telecommunication techniques such as described above.

As an alternative to the microcontroller or microcomputer noted above, the machine intelligence of IAD 135 may reside in a removable module, which may include, for example, a programmable logic controller (PLC). As is generally known in the art, a PLC is a ladder-logic controller which may be capable of controlling the functionality or operation of a plurality of devices. On the other hand, a PLC or other device with limited computing capability may have neither sufficient networking capability nor sufficient processing throughput to enable network-based monitor and control of remote devices. Accordingly, in an embodiment employing a PLC, an additional module may be implemented to provide the intelligence necessary to enable remote monitoring and control across a network.

FIG. 3 is a simplified block diagram illustrating another embodiment of an industrial automation device. In the FIG. 3 embodiment, IAD 135 generally comprises a PLC 1310 and a network interface module 1320. PLC 1310 generally corresponds to the PLC described above with reference to FIG. 2. Those of skill in the art will recognize that use of PLC 1310 in combination with network interface module 1320 represents only one exemplary embodiment; the FIG. 3 embodiment of IAD 135 may incorporate all of the functionality and operational characteristics set forth in detail above with reference to FIGS. 1 and 2.

PLC 1310 generally comprises a PLC processor 1315, a storage medium or memory 1316, and a series of data ports 1311-1314; data port 1311 is illustrated as coupled to a sensor 11, while data port 1312 is illustrated as coupled to an actuator 12, as described above. In operation, two-way data communication between the foregoing components may be enabled through respective couplings to a communications backplane 198 which may include the functionality and operational characteristics of bus 199 described above in detail with reference to FIG. 1.

Network interface module 1320 comprises a processor 1325, a storage medium or memory 1326, an additional computer-readable storage medium 1327, a network interface 1328, and a backplane interface 1329. Two-way data communication between the foregoing components may be enabled through respective couplings to a bus 197 such as described above. In operation, network interface module 1320 may transmit data signals to, and receive data signals from, PLC 1310 though backplane 198 via backplane interface 1329; such two-way data communication may be enabled, for example, through data port 1314, as shown. Additionally or alternatively, network interface module 1320 may be coupled directly to backplane 198.

In the FIG. 3 embodiment, network interface module 1320 may be implemented to provide the intelligence and networking capacity necessary to enable monitoring and control of a remote device across a network. In that regard, processor 1325 may be any microprocessor or microcontroller known in the art capable of running a real-time operating system, which may be programmed or encoded, for instance, in memory 1326. Additionally or alternatively, software programming instructions for controlling operation of processor 1325 may also be encoded or stored in storage medium 1327; further, programming instructions related to the functionality of processor 1325 may reside at a remote device, computer server, or storage medium 150, for example, which may be accessed through network 110 as illustrated in FIG. 1.

Memory 1326 may represent any computer-readable memory known in the art including, but not limited to: read only memory (ROM); random access memory (RAM); erasable/programmable read only memory (EPROM); non-volatile RAM; flash, bubble, or transistor-based memory; memory sticks; magnetic disk drives; or other computer-readable memory devices known in the art for storing and retrieving data.

Similarly, storage medium 1327 may be a conventional read/write memory storage device such as a magnetic disk drive, an optical, magneto-optical, or floppy disk drive, a CD-ROM drive, a DVD drive, and the like.

Network interface 1328 may be any interface known in the art for communicating or transferring files across a computer network as discussed above with reference to FIG. 2. Implementation of network interface module 1320 enables a remote network client, such as host 120 in FIG. 1, for example, to communicate with processor 1325 across a network via network interface 1328.

In turn, backplane interface 1329 may enable network interface module 1320 and processor 1325 to communicate with PLC processor 1315 via backplane 198; backplane 198 signals may include addressing, control, data, and power transmissions. It will be appreciated that the component arrangement illustrated in FIG. 3 may enable remote monitoring and control of sensor 11, actuator 12, and any other devices coupled to PLC 1310. Such monitoring and control may be implemented directly by processor 1325, for example, or by a remote networked device indirectly, i.e. across a network and using processor 1325 as an intermediary.

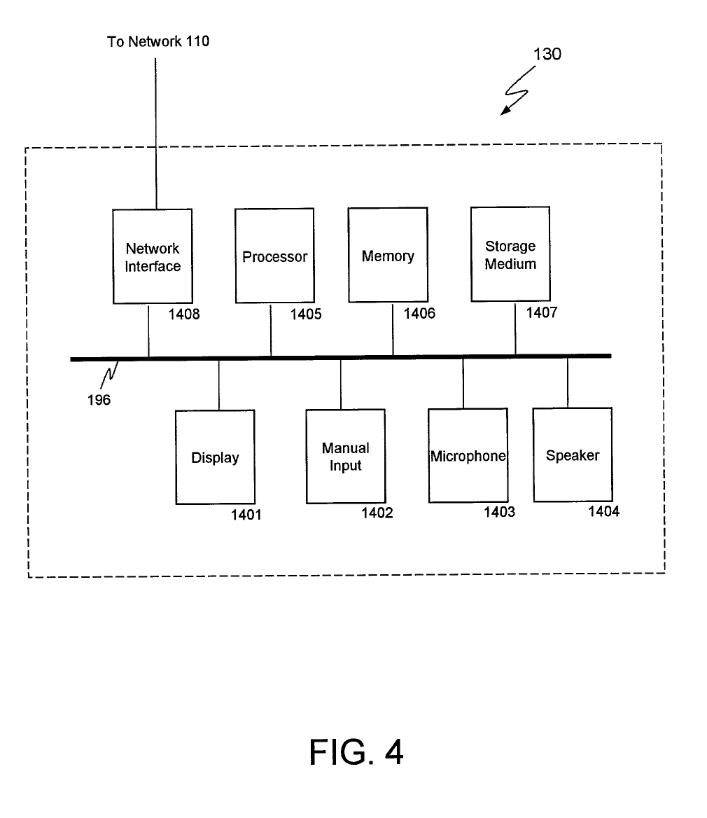

FIG. 4 is a simplified block diagram illustrating one embodiment of an address management server for use in conjunction with a system and method of dynamically addressing and configuring a remote device. AMS 130 may correspond to the AMS described above with reference to FIG. 1, and may incorporate all of the functionality and operational characteristics set forth above. In that regard, AMS 130 may be embodied in a computer server, for example, and may be configured to run a multi-tasking operating system as is generally known in the art. AMS 130 comprises at least one processor 1405 coupled to other components described below via a bus 196 as illustrated in FIG. 4. Processor 1405 may be any microprocessor or microcontroller known in the art.

The software code or programming instructions for controlling the functionality of processor 1405 may be encoded in memory 1406 or stored in storage medium 1407. Memory 1406 and storage medium 1407 may be any computer-readable memory known in the art, as discussed above. Additionally or alternatively, some software or instruction code related to operation of processor 1405 may reside at a remote device or storage medium 150 accessible through network 110, as described above with reference to FIG. 1. Network interface 1408 may enable the foregoing network communication, and may be any interface known in the art for communicating or transferring files across a computer network as set forth in detail above.

Processor 1405 may communicate via bus 196 with a plurality of peripheral equipment, including network interface 1408, for example, enabling two-way network data communications as described above. Additional peripheral equipment may include a display 1401, a manual input device 1402, a microphone 1403, and a speaker 1404.

Display 1401 may be a visual display such as a cathode ray tube (CRT) monitor, a liquid crystal display (LCD) screen, a touch-sensitive screen, or other monitor device known in the art for displaying images and text. Manual input device 1402 may be a conventional keyboard, keypad, mouse, trackball, or other input device. It will be appreciated that more than one such device 1402 coupled to bus 196 may be desirable.

Microphone 1403 may be any suitable microphone as is known in the art for providing audio signals to processor 1405. In addition, speaker 1404 may be included in AMS 130 for reproducing audio signals generated by processor 1405. It will be appreciated by those of skill in the art that microphone 1403 and speaker 1404 may include appropriate digital-to-analog and analog-to-digital conversion circuitry, as appropriate.

In operation, AMS 130 may employ a dynamic network addressing protocol to assign network addresses to remote devices such as the IADs described with reference to FIGS. 1-3. For example, AMS 130 may assign a remote device a unique network address using DHCP. As set forth above, such implementation of a dynamic protocol may eliminate the requirement that a remote network client be re-booted in order to recognize a newly added (i.e. previously unknown) networked device. In cases of network or component failure, for example, or to facilitate system scalability, a dynamic network addressing protocol may enable AMS 130 to assign network addresses to newly added devices in near real-time; accordingly, data transmission from network clients may be re-routed to newly added devices through AMS 130 without requiring that the network clients be re-booted.

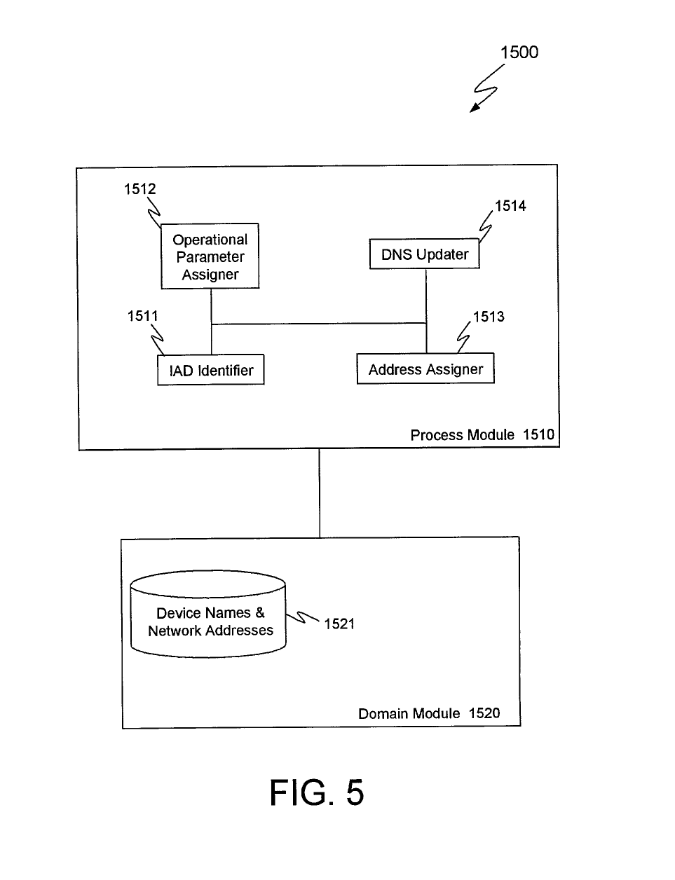

FIG. 5 is a simplified block diagram illustrating one embodiment of an apparatus facilitating dynamic addressing and configuration of a remote device. The apparatus 1500 illustrated in FIG. 5 may be implemented in the form of programming instructions or computer-readable code embodied, for example, in software, firmware, hardware, or a combination thereof, resident on an AMS, such as described above with reference to FIGS. 1 and 4.

Apparatus 1500 may generally comprise a process module 1510 and a domain module 1520. As illustrated in FIG. 5, process module 1510 may include an IAD identifier 1511, an operational parameter assigner 1512, a network address assigner 1513, and a DNS updater 1514. Domain module 1520 may include a data table or other data structure, represented by database 1521, in which a domain name or other unique identification string may be associated with each network address. It is noted that apparatus 1500 may additionally include suitable hardware, software code, and interfacing structure to enable coupling of apparatus 1500 to a network, for example, as designated by reference numeral 110 in FIG. 1; such hardware components and software blocks are omitted from FIG. 5 for clarity.

In operation, process module 1510 may be apprised of the existence of an unknown IAD connected to the network. As generally described above with reference to FIG. 1, apparatus 1510 may periodically query, or ping, the network at predetermined time intervals, for example, seeking newly coupled or unknown devices; additionally or alternatively, a newly networked device may be configured to broadcast a request to be identified, or to transmit such a request directly to apparatus 1500.

Responsive to notification at process module 1510 of the existence of an unknown device on the network, IAD identifier 1511 may identify the unknown device. Identification may entail ascertaining one or more of the following characteristics: a unique, physical network location (i.e. network port or node identifier) or other identifying indicia associated with the device or its particular network connection; current operational characteristics, configuration, or intended functionality of the device; or any other suitable information which may indicate to IAD identifier 1511 what the unknown device is, where it is located, and its intended purpose.

Network address assigner 1513 may assign a current network address to the newly identified device to enable bi-directional data transmission to and from the device across the network. In accordance with some embodiments, the assigned network address may be dynamic; as is generally known in the art, dynamic network addressing protocols may provide system-wide flexibility and fault tolerance.

Additionally, operational parameter assigner 1512 may configure the newly identified device in accordance with system requirements. For example, upon identification, a device may transmit a request for updated or newly assigned configuration information. Operational parameter assigner 1512 may provide such a requesting device with data and instructions relating to operational guidelines, performance characteristics, and the like. Additionally or alternatively, operational parameter assigner 1512 may be configured to transmit such data and instructions automatically, eliminating the need for transmission (by the device) and receipt (by process module 1510) of a request.

As noted generally above, operational parameters may include or relate to operational guidelines, performance characteristics, and so forth. For example, operational parameters may include channel scaling information, specific control program instructions, network-specific configurations, data capture frequencies or other timing information, data ranges or thresholds, and the like. The foregoing list is presented by way of example only, and not by way of limitation. Additionally, parameters or operational information may include data or program procedures for instructing, requesting, or otherwise causing the newly added device to access operational parameter information from another source on the network, such as another operational parameter assigner 1512, for example.

Where dynamic network addressing protocols are implemented, DNS updater 1514 may apprise a DNS of the dynamic network address assigned to the newly networked device. In that regard, domain module 1520 may include a data table or other data structure, represented by database 1521, in which a unique identification string such as a domain name may be associated and cross-referenced with each assigned dynamic network address. Though apparatus 1500 depicted in FIG. 5 integrates the foregoing functionality with the capabilities of an AMS as set forth above, it will be appreciated that domain module 1520 and database 1521 may reside on a remote computer server or dedicated DNS, for example, as illustrated and described above with reference to FIG. 1.

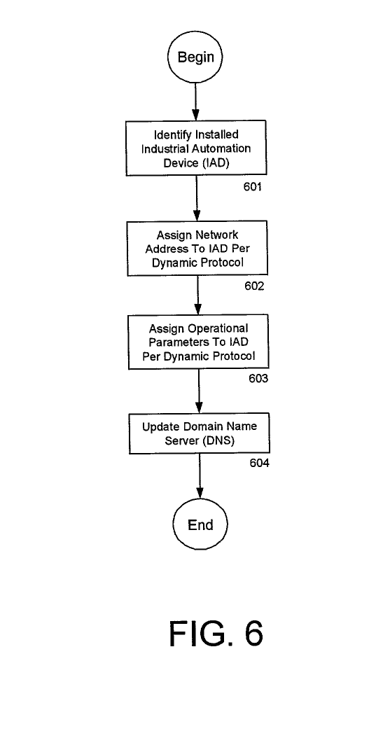

FIG. 6 is a simplified flow diagram illustrating a general operational flow of one embodiment of a method of dynamically addressing and configuring a remote device. The method depicted in FIG. 6 may be enabled by a system or apparatus such as described in detail with reference to FIGS. 1-5.

As indicated at block 601, an AMS or other device (such as apparatus 1500 in FIG. 5, for example) may identify a newly connected or otherwise unknown IAD on the network. This identification may be responsive to a request, broadcast or otherwise, from the IAD, or may result from periodic queries of the network for newly added devices as described in detail above.

A newly identified IAD may then be assigned a network address in accordance with a dynamic protocol (as indicated at block 602), enabling network clients and other networked devices to engage in two-way data communication with the IAD. The assigned address may be an IP address, for example, depending upon the network communication protocol and system configuration. As set forth in detail above, a dynamic network addressing protocol such as DHCP may be implemented to assign this network address, providing the networked system with previously unattainable flexibility and redundant fault tolerance characteristics.

Additionally, an IAD may be selectively configured in accordance with local and global system requirements as described above; in that regard, an AMS or other network client may assign operational parameters governing the functionality and performance characteristics of the IAD (block 603). For example, the operational parameters may indicate whether the IAD will operate as an input or an output device, delineate an IAD input voltage range or scaling factor, define a linearization value, establish data capture procedures, and the like. Those skilled in the art will appreciate that the operational parameters employed to configure the IAD may generally be a function of the intended operational characteristics of the system as a whole.

As indicated in block 603, the IAD may be assigned operational parameters in accordance with a dynamic network addressing protocol as described above. Data and instructions required for configuring the IAD may be transmitted directly; alternatively, a network address or path may be transmitted to the IAD, causing the IAD to establish two-way data communication with another device on the network serving as a source for data and instructions relating to operational parameters.

As indicated at block 604, a DNS may be updated with the newly assigned network address for the IAD; it will be appreciated that the functionality of a DNS may reside on a remote computer server or other network client responsible for maintaining a data structure associating network addresses with unique identifiers. As described above with reference to FIG. 5, it is within the scope and contemplation of the invention to retain such functionality on the AMS itself.

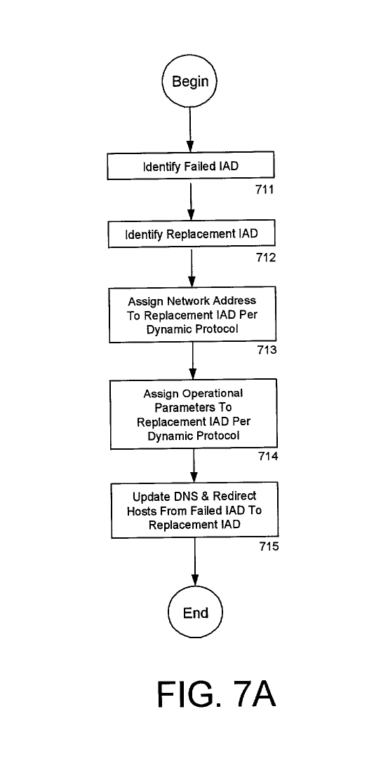

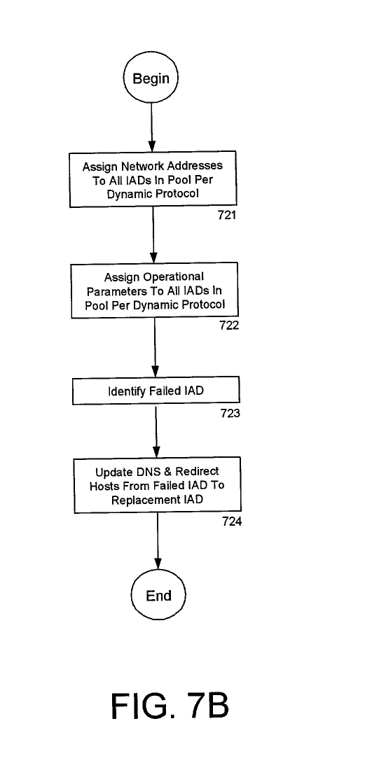

FIG. 7A is a simplified flow diagram illustrating the general operational flow of another embodiment of a method of dynamically configuring a remote device. The method depicted in FIG. 7A may be enabled by a system or apparatus such as described in detail with reference to FIGS. 1-5. In particular, FIG. 7A illustrates an embodiment facilitating fault tolerant IAD replacement, for example, when another IAD fails.

In accordance with the method illustrated in FIG. 7A, an AMS or other network client may identify a failed IAD at block 711. An IAD may be characterized as “failed” if its behavior is non-responsive to attempted network communications, for example, or if it otherwise fails to communicate with other network devices; similarly, an IAD may be characterized or identified as “failed” in cases where the IAD ceases to operate properly, notwithstanding operative communication connections. At block 712, the AMS which has identified the failed IAD may then identify a replacement IAD coupled to the network. A replacement IAD may be coupled to the network after the AMS has detected the failure of an original IAD, for example; alternatively, as set forth in detail below with reference to FIG. 7B, a replacement IAD may be coupled to the network before an IAD fails, for example, in a pool of redundant hardware devices for use in the event of IAD failure.

Upon identifying a suitable replacement IAD, an AMS may assign the replacement IAD a network address according to a dynamic protocol as described above. This assignment is represented at block 713. A dynamic protocol such as DHCP, for example, may be utilized to assign the network address, as noted above.

As indicated at block 714, a replacement IAD may then be configured in accordance with assigned operational parameters relating to the intended operational characteristics or functionality of the replacement IAD. A DNS or similar device may then be updated with the network address assigned to the replacement IAD (block 715). As set forth in detail above, hosts or network clients engaged in data communication with the failed IAD may be dynamically re-routed to the replacement IAD.

The FIG. 7A embodiment need not be employed only as a method of providing a replacement IAD upon the failure of another IAD. Implementation of dynamic protocols for device addressing and configuration may enable additional devices to be added to, and recognized by, an operating network; accordingly, a networked system such as illustrated in FIG. 1 may be scaled as requirements dictate.

FIG. 7B is a simplified flow diagram illustrating the general operational flow of another embodiment of a method of dynamically addressing and configuring a remote device. As with the embodiments of FIGS. 6 and 7A, the method depicted in FIG. 7B may be enabled by a system or apparatus such as described in detail with reference to FIGS. 1-5. In particular, FIG. 7B illustrates the general operation of an embodiment employing a pool of replacement or redundant hardware. As noted briefly above, such a pool may represent one or more IADs or other networked devices coupled to the network which may be selectively brought into service as desired, such as in response to IAD failure or increased system load.

In creating such a pool of replacement or redundant devices, an AMS may assign a network address, such as an IP address, to each IAD or device within the pool (block 721). As with the embodiments described in detail above, a dynamic protocol such as DHCP, for example, may be utilized to assign this network address.

As indicated at block 722, each IAD within the pool may be assigned operational parameters, configuring each IAD according to a desired functionality, as described above. Having been addressed and configured according to a dynamic protocol, each IAD in the pool may be implemented as needed, either upon failure of an original system component, for example, or in response to increased system requirements.

In the FIG. 7B embodiment, an AMS may identify a failed IAD at block 723. Such identification may generally correspond to the IAD failure described above with reference to FIG. 7A. Additionally or alternatively, an AMS may simply identify an unmet requirement in the network, such that implementation of an IAD from the pool is desirable.

Block 724 represents implementation of an IAD from the pool; a DNS or similar device may be updated with the network address assigned to the newly implemented IAD. As set forth in detail above, where an IAD is implemented as a replacement in cases of hardware or communication failure, hosts or network clients engaged in data communication with a failed IAD may be dynamically re-routed to the replacement IAD brought into service from the pool. In cases where the networked system is simply being scaled to include an additional IAD from the pool, network clients may be routed directly to the network address of the additional IAD.

Implementation of a dynamic addressing protocol may enable dynamic addition and replacement of hardware in an operating system, i.e. an “infinitely up,” fault tolerant system. On-line redundant backup hardware may be available on demand and configured as necessary. Additionally, such a system facilitates the foregoing device auto-discovery enabled by the address request nature of a dynamic addressing protocol.

Since dynamic addressing resolution methods enable conversion of a device “name” or other identifier into a matching current dynamic network address, system calls to a failed IAD or other networked device may be dynamically re-routed to a device which is known to be operational. A dynamic backup implementation enables a failed unit to be replaced by a dynamically addressed device, which may then be re-referenced through the addressing resolution method. Accordingly, a network client's “named” request (i.e. a request directed to a domain name or other identifier, rather than to a specific network address) may be dynamically directed based on the system's current performance, configuration, and load characteristics.

Those of skill in the art will appreciate that dynamic accessing methods may also benefit from a common protocol service request port implemented at each networked device. Network clients attempting to access an IAD may inquire about available services, and may subsequently be routed to an appropriate port or another destination address.

As described above, dynamic location of hardware may be reverse-discovered via a broadcast request, i.e. broadcasting one or more data packets to the network may enable a client to ascertain the current location or dynamic address of any device on the network. The device or IAD whose location is sought may respond to the broadcasting transmitter with a data transmission, including current address information, directed specifically to the broadcasting device. Such a device location strategy may reduce address location overhead through a server resource on the network.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the invention. Therefore, it is intended that the invention be considered as limited only by the scope of the appended claims.

What is claimed is:

1. A method of addressing and configuring a remote device; said method comprising:
identifying an input/output device coupled to a network;
assigning a network address to said device in accordance with a dynamic protocol; and
configuring said device with operational parameters in accordance with a dynamic protocol.

2. The method of claim 1 further comprising updating a data structure in accordance with said assigning.

3. The method of claim 1 wherein said identifying comprises ascertaining a physical location of said device on said network.

4. The method of claim 1 wherein said assigning comprises assigning a dynamic network address to said device using Dynamic Host Configuration Protocol.

5. The method of claim 1 wherein said configuring comprises transmitting data and instructions to said device using Dynamic Host Configuration Protocol.

6. The method of claim 2 wherein said updating comprises modifying a data structure maintained at a domain name server.

7. The method of claim 1 wherein said configuring comprises transmitting instructions to a programmable logic controller incorporated in said device.

8. An apparatus comprising:
a device identifier configured to identify an input/output device coupled to a network;
an address assigner operative in accordance with a dynamic network addressing protocol to assign a network address to said device; and
an operational parameter assigner operative in accordance with a dynamic protocol to transmit data and instructions related to operational parameters to said device.

9. The apparatus of claim 8 further comprising a database updater operative to modify a data structure in accordance with output from said address assigner.

10. The apparatus of claim 8 wherein said device identifier is operative to ascertain the physical location of said device.

11. The apparatus of claim 8 wherein said address assigner is operative in accordance with Dynamic Host Configuration Protocol.

12. The apparatus of claim 8 wherein said operational parameter assigner operative in accordance Dynamic Host Configuration Protocol.

13. The apparatus of claim 8 wherein said database updater is operative to modify a data structure maintained at a domain name server.

14. The apparatus of claim 8 wherein said device identifier comprises means for detecting a request from a device and wherein said address assigner assigns said network address to said device responsive to said request.

15. The apparatus of claim 8 wherein said operational parameter assigner is operative to transmit data and instructions to a programmable logic controller incorporated in said device.

16. A computer readable medium encoded with data and computer executable instructions for addressing and configuring a remote device; the data and instructions causing an apparatus executing the instructions to:
identify an input/output device coupled to a network;
assign a network address to said device in accordance with a dynamic protocol; and
configure said device with operational parameters in accordance with a dynamic protocol.

17. The computer readable medium of claim 16 further encoded with data and instructions, further causing an apparatus to update a data structure with said network address assigned to said device.

18. The computer readable medium of claim 16 further encoded with data and instructions, further causing an apparatus to ascertain a physical location of said device on said network.

19. The computer readable medium of claim 16 further encoded with data and instructions, further causing an apparatus to assign said network address to said device using Dynamic Host Configuration Protocol.

20. The computer readable medium of claim 16 further encoded with data and instructions, further causing an apparatus to configure said device using Dynamic Host Configuration Protocol.

21. The computer readable medium of claim 16 further encoded with data and instructions, further causing an apparatus to receive a request from said device and to assign said network address responsive to said request.

22. The computer readable medium of claim 16 further encoded with data and instructions, further causing an apparatus to detect a failure of said device and to identify a replacement input/output device coupled to said network.

23. A network-based monitor and control system comprising:
an input/output device coupled to a network;
a host coupled to said network and configured to exchange data and instructions with said device; and
an address management server coupled to said network and operative to assign a network address to said device in accordance with a dynamic protocol.

24. The system of claim 23 wherein said address management server is further operative to configure said device in accordance with a dynamic protocol.

25. The system of claim 23 further comprising a domain name server operative to maintain a data structure associating said network address with an identifier.

26. The system of claim 23 wherein said device is operative to broadcast a request to be identified, and said address management server assigns said network address to said device responsive to said request.

27. The system of claim 23 wherein said address management server is operative to transmit said network address to said host.

28. The system of claim 23 further comprising a replacement input/output device and wherein said address management server is operative to assign a replacement network address to said replacement device in accordance with a dynamic protocol.

29. The system of claim 28 wherein said address management server is operative to transmit said replacement network address to said host.

30. The system of claim 23 wherein said address management server and said domain name server are incorporated in a single computer.

31. The system of claim 24 wherein said device comprises a programmable logic controller operative to receive configuration instructions from said address management server.

32. An input/output device operative in a network-based monitor and control system; said device comprising:
a data port selectively coupled to one of a sensor and an actuator;
a network interface enabling bi-directional data communication between said device and a remote network client; and
a control module coupled to said data port and to said network interface and operative to exchange data and instructions between said data port and said network interface, said control module being operative to receive a network address through said network interface in accordance with a dynamic protocol.

33. The device of claim 32 wherein said control module is operative to transmit a request to be identified through said network interface and wherein said control module receives said network address responsive to said request.

34. The device of claim 32 wherein said control module is operative to receive configuration instructions through said network interface in accordance with a dynamic protocol.

35. The device of claim 32 wherein said network interface enables wireless data communication.

36. The device of claim 32 wherein said control module comprises a programmable logic controller.
